(19) United States
(12) Patent Application Publication
(10) Pub. No.: US 2026/0189550 A1
(43) Pub. Date: Jul. 2, 2026

(54) METHODS AND APPARATUS TO AUTHENTICATE SERVICE CHAINS

(71) Applicant: Musarubra US LLC, San Jose, CA (US)

(72) Inventors: Senthil Kumar Venkatesan, Bangalore (IN); Arthur S. Zeigler, Gaston, OR (US)

(21) Appl. No.: 19/003,369

(22) Filed: Dec. 27, 2024

(51) Int. Cl. H04L 9/40

(52) U.S. Cl. CPC H04L 63/0846

(57) ABSTRACT

Systems, apparatus, articles of manufacture, and methods are disclosed. An example system to authenticate a service chain comprises: a first server device in a network, the first server device to: receive a user token from a tenant device that is outside the network, authenticate the user token, and after the authentication, forward the user token and a server token. The example system also comprises a second server device in the network, the second server device to: receive the user token and the server token from the first server device, authenticate the server token, reauthenticate the user token, and in response to determinations that the server token passes authentication and the user token pass reauthentication, generate an output based on a value within the user token that identifies the tenant device.

### FIELD OF THE DISCLOSURE

This disclosure relates generally to cybersecurity and, more particularly, to methods and apparatus to authenticate service chains.

### BACKGROUND

Cloud computing generally refers to systems in which a tenant device generates a request (e.g., a request for data, a request to perform operations, etc.) that is responded to by one or more remote server devices (e.g., in a cloud). In recent years, the number of workloads submitted by tenant devices and complexity of those workloads has increased. In turn, it is increasingly common for multiple server devices to work together to respond to a given request.

### BRIEF DESCRIPTION OF THE DRAWINGS

FIG. 1 is a block diagram of an example environment in which an example tenant device communicates with a private network.

FIG. 2 is an illustrative example of information stored within a token.

FIG. 3 is an illustrative example of response data used to form the response of FIG. 1.

FIG. 4 is a block diagram of a previous approach to implement the private network of FIG. 1.

FIG. 5 is a block diagram of an example implementation of the private network of FIG. 1.

FIG. 6 is a flowchart representative of example machine readable instructions and/or example operations that may be executed, instantiated, and/or performed by example programmable circuitry to implement the Identity Access Manager (IAM) device as described in FIG. 5.

FIGS. 7A and 7B are flowcharts representative of example machine readable instructions and/or example operations that may be executed, instantiated, and/or performed by example programmable circuitry to implement the private network 108 of FIGS. 1 and 5.

FIG. 8 is a flowchart representative of example machine readable instructions and/or example operations that may be executed, instantiated, and/or performed by example programmable circuitry to authenticate a user token as described in FIG. 7.

FIG. 9 is a block diagram of an example processing platform including programmable circuitry structured to execute, instantiate, and/or perform the example machine readable instructions and/or perform the example operations of FIGS. 6-8 to implement the private network 108 of FIGS. 1 and 5.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 6-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Any number of server devices may communicate with one another to respond to a request. For example, a first server device may generate a first output that corresponds to a tenant device request, then forward the first output and the original request to second server device. The second server device then uses the first output to generate a second output that corresponds to a request, etc. In other examples, the first server device simply passes the request to the second server device without generating an output. As used herein, the combination of server devices used to respond to a given tenant device request is referred to as a service chain.

Server devices that work together to respond to tenant device requests are often managed by a common organization or entity. In many examples, the managing organization implements a network that includes multiple server devices. Generally, different server devices in the network are responsible for the performance of a different set of operations. As a result, server devices in the network can work together in different combinations to form different service chains and respond to different types of tenant device requests.

In many examples, tenant devices that submit requests are managed by separate entities (e.g., consumers, different companies, etc.) than the organization that manages the network of responding server devices. Accordingly, a tenant device that wishes to submit a request to a network is generally required to submit a user token with its request. The user token is a data structure that includes, among other parameters, a) a tenant ID value that identifies a particular tenant device, and b) authentication data. The first server device that communicates with the tenant device (e.g., a server device on the edge of the cloud) uses the authentication data to confirm the user token has not been altered. By doing so, the first server device verifies that the tenant device that submitted the request is trustworthy.

Previous approaches to respond to tenant device requests assume that all server devices within their network are trustworthy. Thus, after verifying the user token, the first server device in previous approaches does not forward the user token to a second server device. Rather, the first server device in such systems extracts the tenant ID from the user token and forwards the tenant ID to the second server device as plain text (e.g., as Hypertext Transfer Protocol (HTTP) parameters).

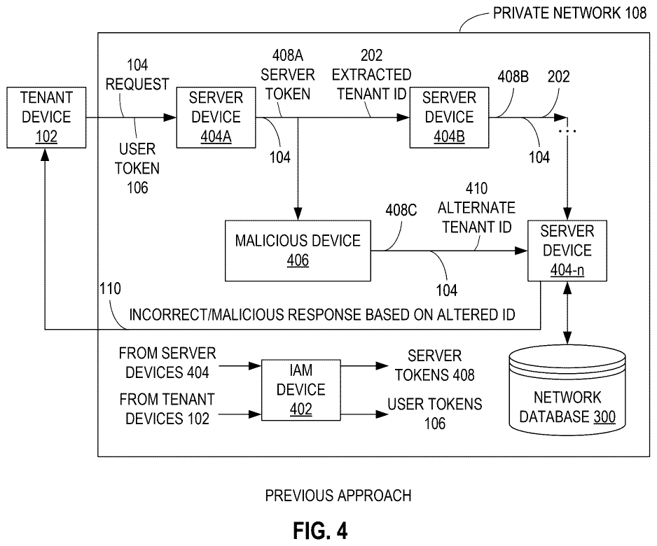

Extracting the tenant ID as described above can reduce bandwidth across the network and reduce the number of operations that subsequent server devices in the service chain need to perform. However, reliance on a presumption that all devices within a network are trustworthy exposes previous approaches to security vulnerabilities. In recent years, malicious actors have leveraged increasingly unique and complex techniques to gain access to private networks. Once a given server in a network is compromised, any intra-network communications in the network become susceptible to man-in-the-middle attacks. That is, a second, third, or any (n+1)th server device that receives the plain text tenant ID may edit the tenant ID in a manner that causes an incorrect response to the request, harms the tenant device, and/or harms one or more server devices in the network. Such attacks on networks implemented using previous approaches are described further in connection with FIG. 4.

Man-in-the-middle attacks can also lead to bad actors in the private network compromising and/or exfiltrating tenant information. For example, assume tenant A is a valued customer. Assume further that tenant B is a bad actor who also controls a malicious server device within the private network. When the request for account information comes from tenant B, the malicious server device substitutes the tenant ID of B with A and thus, a downstream server device returns account information from tenant A to tenant B.

Example methods, apparatus, and systems disclosed herein implement a service chain with secure intra-network communications. After authenticating the user token, an example first server device forwards both the original token to a second server device and a server token that identifies the first server token. Subsequent server devices in an example service chain then have the option to re-authenticate the user token themselves before forwarding the tenant device request or generating an output. Thus, insta-service authentication disclosed in examples herein can include both server token and user token authentication. Accordingly, if a malicious actor does gain access to an example network, a server device in the example service chain is able to identify if it has received an invalid user token because said token will fail authentication.

As an example, assume a first server device forwards a client request to a second server device without generating an output. In this situation, the first server device handles the client request by formulating a downstream query to the second server device using service-to-service authentication. In previous approaches, the second server device would not validate the original request but instead assume that the first server device did so. Examples described herein resolve this security risk by allowing the second server device to also attest that the original client request has not been tampered with and to trust only the tenant ID from the client. The second server device also trusts the first server device via the service-to-service authentication. Advantageously, examples described herein add a level of defense in depth to the request by validating not only the service-to-service authentication but also that the identity of the client has not been tampered with by the first server device.

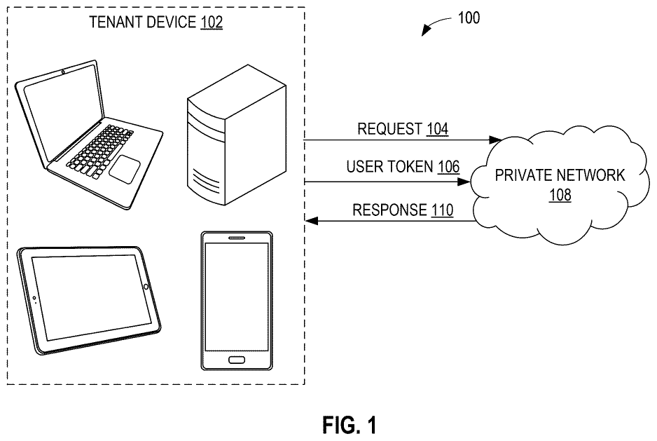

FIG. 1 is a block diagram of an environment 100 in which a tenant device communicates with a private network. The example environment 100 includes an example tenant device 102, an example request 104, an example user token 106, an example private network 108, and an example response 110.

The tenant device 102 refers to any device that generates a request 104. In some examples, the tenant device 102 is a consumer-facing device (a laptop, a tablet, a smart phone, etc.) that generates the request 104 based on human input. In other examples, the tenant device 102 is a server device that generates the request without human input. In such examples, the request 104 may be automatically generated in response to the passage of a threshold amount of time, the server device receiving certain data from an external device, a different type of logical condition becoming satisfied, etc.

The tenant device 102 may include any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

The request 104 refers to data that is transmitted by the tenant device 102, and that instructs (e.g., requests) a different device to perform operations. The requested operations may be any type of operations that the tenant device 102 chooses not to, or is unable to, perform itself. Accordingly, the request 104 may correspond to any type of task. For example, the request 104 may be implemented as a request to obtain data stored in an external database, browse a webpage, render a video, train a machine learning model, etc. In some examples, the request 104 is formatted as an Application Programming Interface (API) call. In other examples, the request 104 is transmitted in a different format. The tenant device 102 may generate the request 104 rather than performing the operations itself for any reason, including but not limited to a lack of computational resources, a lack of information, etc.

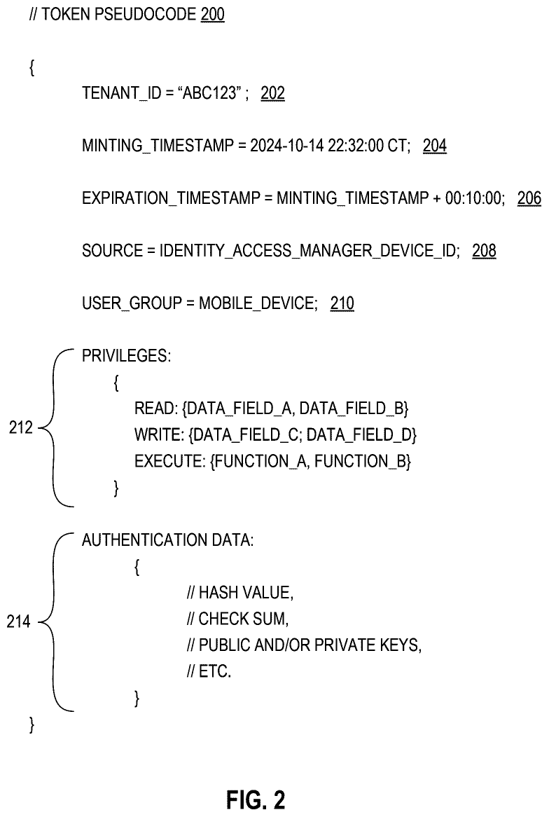

The tenant device 102 also generates the user token 106. As described above, the user token is a data structure that includes, among other parameters, a) a tenant ID value that identifies the tenant device 102, and b) authentication data. As described further in FIG. 2, the authentication data represents a digital signature of the payload message data by a trusted source (an Identity Access Manager device). The authentication data therefore provides tamper protection of the tenant ID value. The tenant device 102 transmits the request 104 and the user token 106 together. Thus, an external device can analyze the user token 106 to verify the tenant device 102 is authorized to submit the request 104.

Advantageously, the user token 106 disclosed by examples herein is the same user token 106 used in previous approaches that rely on trust within the private network 108. Thus, a manufacturer or designer of the private network 108 can implement the examples disclosed herein to improve the security of service chains without imposing any requirements or changes on independent tenant devices. The user token 106 is described further in connection with FIG. 2.

The private network 108 refers to one or more devices that communicate with one another to respond to requests. The private network 108 may employ any subset of devices within the network to respond to a given request 104. The ordered sequence of devices within the private network 108 that communicate with one another to accept the request 104 as an input and generate the response 110 may be referred to as a service chain.

In this example, the private network 108 is referred to as private because the one or more devices within the network are managed by a common organization. For example, the private network 108 may be implemented by Amazon Web Services (AWS), Microsoft Azure, etc. In other examples, the private network 108 is implemented by a different cloud computing service or managed by a different type of organization.

The private network 108 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The response 110 refers to a message, sent from the private network 108 and to the tenant device 102, that includes the result of the request 104. The response 110 may include any subject matter and be implemented using any format. In this example, the private network 108 generates the response 110 by obtaining one or more parameters from a network database.

FIG. 2 is an illustrative example of information stored within a token. In the examples below, the pseudocode 200 is described as a representation of the data within the user token 106 of FIG. 1. In other examples, the pseudocode 200 may represent any user token from any tenant device or any of the server tokens used within the private network 108. Server tokens are described further in connection with FIGS. 4-8 . In the example of FIG. 2, the pseudocode 200 includes an example tenant ID 202, an example minting timestamp 204, an example expiration timestamp 206, a source parameter 208, an example user group 210, example privileges 212, and example authentication data 214.

The tenant ID 202 refers to a value that identifies the tenant device 102. In the example of FIG. 2, the tenant ID 202 is a string of alphanumeric characters. In other examples, the tenant ID 202 includes other types of characters. More generally, the tenant ID may be implemented using any suitable data type, including but not limited to strings, characters, floats, integers, vectors, etc.

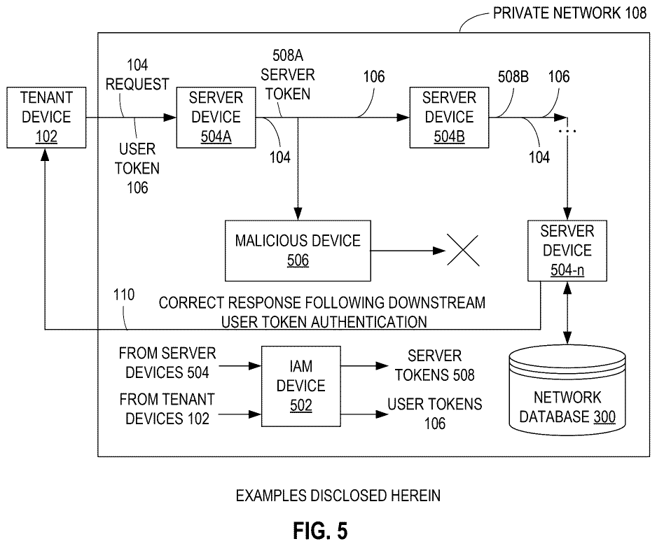

The minting timestamp 204 describes the date and time at which the user token 106 was minted. In general, user tokens are minted by an Identity Access Manager (IAM) device that is trusted by the private network 108. The tenant device 102 generally asks the IAM device for a user token whenever a request is generated. Because the tenant device 102 may generate any number of requests at any time and for any reason, the IAM device may also mint user tokens at any time. In some examples, minting a user token may also be referred to as generating, producing, or creating a token. The IAM device is described further in connection with FIGS. 4 and 5.

The expiration timestamp 206 describes the date and time at which the user token 106 becomes invalid. In previous approaches, user tokens are designed to be used by only a first device (e.g., an edge device) within the private network 108. The first device in such systems is expected to validate the user token 106 within a certain amount of time (e.g., ten minutes in FIG. 2). Designers and manufacturers of private networks in previous approaches therefore require that user tokens include an expiration timestamp so that any usage of the user token that occurs after the expiration timestamp can be identified as invalid and/or malicious. Furthermore, because the user token 106 in examples herein can be the same user token used by the tenant device 102 in previous approaches, the pseudocode 200 also includes the expiration timestamp 206. The difference between the expiration timestamp 206 and the minting timestamp 204 may be referred to as the lifespan of the user token 106. In some examples, the lifespan of the user token is a value other than ten minutes.

The source parameter 208 is a value that identifies the device that minted the user token 106. In the example of FIG. 2, the source of the user token 106 is an IAM device as described above. In other examples, the source of the user token 106 is a different type of device. The source parameter 208 may include be implemented using any suitable type, including but not limited to a string of alphanumeric and/or special characters as described above.

The tenant device 102 may be one of any number of devices that transmit requests to the private network 108. Accordingly, in some examples, the private network 108 groups devices together to more efficiently coordinate response generation. In the example of FIG. 2, the user group 210 identifies one or more groups that the tenant device 102 belongs to. The private network 108 may coordinate with the IAM device to establish any type of criteria for forming groups, including but not limited to groups that describe the type of device making a request (e.g., mobile devices in FIG. 2).

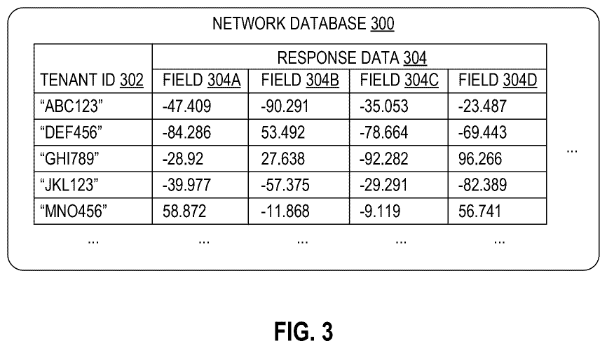

The privileges 212 refer to the type of operations that the tenant device 102 is allowed to include in the request 104. In the example of FIG. 2, devices within the private network 108 can access a network database and perform functions. Accordingly, the privileges 212 indicate which data fields the tenant device 102 is allowed to request a read from, which data fields the tenant device 102 is allowed to request be written over, and which functions the tenant device 102 is allowed to request be executed. The network database referred to in the foregoing example is described further in connection with FIG. 3. In other examples, the privileges 212 include other types of permissions in addition to or instead of read, write, and execute.

The authentication data 214 refers to any data that is used by an external device (e.g., a server device in the private network 108) to authenticate, verify, etc. that the information in the user token is accurate. Accordingly, the authentication data 214 may include but is not limited to a hash value, a check sum, public and/or private keys, other cryptographic/encryption data, etc.

The pseudocode 200 is one example of parameters that are used to implement the user token 106. The user token 106 may additionally or alternatively include other parameters besides those shown in FIG. 2. In some examples, the user token 106 is implemented as a JSON Web Token (JWT). In other examples, the user token 106 is formatted differently.

FIG. 3 is an illustrative example of response data used to form the response of FIG. 1. FIG. 3 shows an example network database 300, which includes example tenant IDs 302 and example response data 304. The response data 304 includes fields 304A, 304B, 304C, 304D.

The network database 300 is an example of the network database described above in reference to FIG. 2. Accordingly, the tenant device 102 is permitted to access a portion of the network database 300 as described by the privileges 212 within the user token 106. More generally, different devices that are external to the private network 108 may be permitted to access different portions of the network database 300.

The response data 304 refers to data that is used by one or more devices within the private network 108 to form responses. For example, the private network may generate the response 110 by providing one or more values from the fields 304A-304D, by combining one or more values of the fields 304A-304D using mathematical operations, by executing one or more functions using one or more values of the fields 304A-304D, etc. The example of FIG. 3 shows the response data 304 includes four fields that are each formatted as floats. More generally, the response data 304 may include any number of fields and may store data in any format.

The example of FIG. 3 also shows that the data within the network database 300 is partitioned, sliced, organized, etc. according to the tenant ID 302. For example, a device within the private network 108 that uses the value tenant ID=“abc123” to access the network database 300 would receive approximately −47.409 as the value of field 304A, approximately −90.291 as the value of field 304B, approximately −35.053 as the value of field 304c, and approximately −23.487 as the value of field 304D. However, a device within the private network 108 that uses the value tenant ID=“def456” to access the network database 300 would receive approximately −84.286 as the value of field 304A, approximately 54.492 as the value of field 304B, approximately −78.664 as the value of field 304C, and approximately −69.443 as the value of field of 304D. Thus, the accuracy of the response 110 is dependent on what value of the tenant ID 302 is used by the device(s) within the private network 108 accessing the network database 300.

The network database 300 may be implemented with any type of memory. For example, the network database 300 may include a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

FIG. 4 is a block diagram of a previous approach to implement the private network 108 of FIG. 1. In the previous approach of FIG. 4, the private network 108 includes an IAM device 402, server devices 404A, 404B, . . . , 404-n (collectively referred to as server devices 404), a malicious device 406, and the network database 300 of FIG. 3. FIG. 4 also includes the tenant device 102, the user token 106, and the response 110 of FIG. 1, the tenant ID 202 of FIG. 2, server tokens 408A, 408B, 408C (collectively referred to as server tokens 408), and an alternate tenant ID 410.

The IAM device 402 provides access to the private network 108 based on the identities of devices as described above in reference to FIG. 2. Thus, the IAM device 402 mints the user token 106 based on instructions from the tenant device 102. In some approaches, the instructions from the tenant device 102 may include credential information such as an email or username, a password, etc.

The server devices 404 form a service chain by collectively working together to respond to the request 104. As the first server device within the tenant device 102, the server device 404A receives both the request 104 and the user token 106. The server device 404A forwards the request 104 to the server device 404B. The server device 404A also transmits a server token 408A to the server device 404B. The server tokens 408 are data structures that are used by the server devices to verify the identity of one another. The IAM device 402 generates the server tokens 408 based on instructions from the server devices 404 or the malicious device 406. In some examples, server tokens are referred to as service-to-service tokens.

The server device 404A also uses the user token 106 to verify the identity of the tenant device 102 and confirm the tenant device 102 is authorized to submit the request 104. In the previous approach of FIG. 4, the server device 404A then extracts the tenant ID 202 (e.g., “abc123” as shown in FIG. 2) from the user token 106, forwards the extracted tenant ID 202 to the server device 404B, and discards the rest of the user token 106. The previous approach forwards only the extracted tenant ID 202 to improve bandwidth and network efficiency as described above.

An intermediate server device (e.g. 408B) in the service chain authenticates a received server token (e.g., 408A) to verify the request 104 and the extracted tenant ID 202 has been forwarded by a trusted device. The intermediate device then sends a new server token (e.g., server token 408B) that identifies itself, the request 104, and the extracted tenant ID 202, to another device in the service chain. The foregoing operations repeat until the request 104 and the extracted tenant ID 202 reaches the last device in the service chain (e.g., the server device 404-n).

The server device 404-n transmits the response 110 to the tenant device 102. The server device 404-n also generates the response 110 based on the request 104 and a tenant ID. In the previous approach of FIG. 4, the server device 404-n receives two instances of the request 104 from two separate devices.

The first copy (in chronological order) of the request 104 received by the server device 404-n is sent from the malicious device 406. The malicious device 406 refers to a device that is trusted within the private network 108 and is therefore able to obtain a server token 408C from the IAM device 402. Despite being trusted, the malicious device 406 has been compromised and works against the interest of the private network 108. The malicious device 406 may be compromised for any reason, including but not limited to the actions of a malicious actor within the managing organization, a security vulnerability, etc.

In the previous approach of FIG. 4, the server devices 404 extract the tenant ID 202 and forward it as plain text in reliance on a presumption that all of the devices within the private network 108 are trustworthy. However, if the private network 108 becomes compromised, the malicious device 406 can take advantage of this presumption by intercepting or obtaining a copy of the tenant ID 202 as plain text while the data is transmitted between server devices (e.g., between server devices 402A and 402B in FIG. 4). The plain text format allows the malicious device 406 to generate an alternate tenant ID 410 that is based on, but different from, the tenant ID 202.

The malicious device 406 transmits a copy of the request 104, the server token 408C, and the alternate tenant ID 410 to the server device 404-n. The server device 404-n verifies the server token 408C is minted by the IAM device 402 and therefore treats the malicious device 406 in the same manner it would treat a device that sent one of the other server tokens 408. That is, the server device 404-n trusts the malicious device 406 and believes the alternant tenant ID 410 was originally extracted from the user token 106. The server device 404-n therefore uses the alternate tenant ID 410 to access the network database 300 and obtains different portions of the response data 304 than it would have if the extracted tenant ID 202 had been used.

Moreover, the server devices 404 (including those that are not malicious) regularly manipulate and/or reformat the request 104 to ensure the next server device downstream in the service chain can understand the request and determine their role in generating the response 110. Thus, in addition to providing the alternate ID 410, the malicious device 406 may alter the request 104 in a harmful manner. Accordingly, the server device 404-n generates and transmits an incorrect response 110 to the tenant device 102 based on the alternate tenant ID 410 and/or the improperly altered request 104. The response may additionally be harmful, misleading, and/or malicious towards the tenant device 102, may be sent to a different destination instead of the tenant device, etc.

In FIG. 4, the server device 404-n does eventually receive the extracted tenant ID 202 from the service chain. However, the extracted tenant ID 202 is received after the alternate tenant ID 410 and therefore does not prevent the server device 404-n from transmitting an incorrect/malicious response 110 to the tenant device 102. In general, the previous approach of FIG. 4 allows a malicious device to intercept or copy the tenant ID at any point within the service chain, thereby exposing both the private network 108 and the tenant device 102 to security vulnerabilities.

FIG. 5 is a block diagram of an example implementation of the private network 108 of FIG. 1 described herein to securely generate a response to a request. In the example of FIG. 5, the private network 108 includes an IAM device 502, server devices 504A, 504B, . . . , 504-n (collectively referred to as server devices 504), a malicious device 506, and the network database 300 of FIG. 3. FIG. 5 also includes the tenant device 102 and the user token 106 of FIG. 1, the tenant ID 202 of FIG. 2, and server tokens 508A and 508B (collectively referred to as server tokens 508).

The private network 108 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the private network 108 of FIGS. 1 and 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIGS. 1 and 5 may, thus, be instantiated at the same or different times. Some or all of the circuitry of FIGS. 1 and 5 may be instantiated, for example, in one or more threads executing concurrently on hardware and/or in series on hardware. Moreover, in some examples, some or all of the circuitry of FIGS. 1 and 5 may be implemented by microprocessor circuitry executing instructions and/or FPGA circuitry performing operations to implement one or more virtual machines and/or containers.

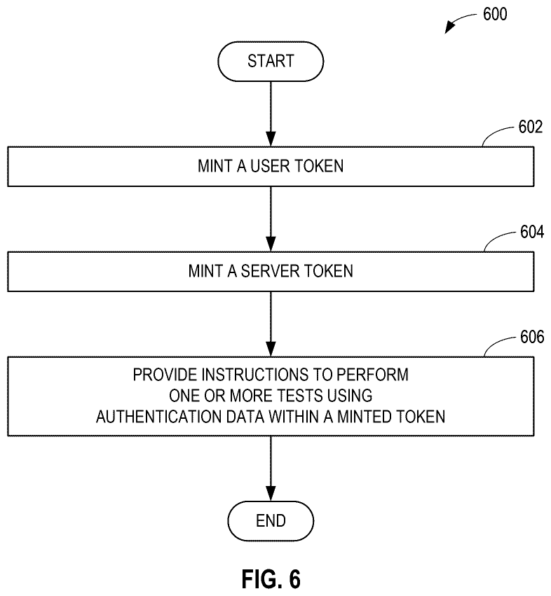

Like the IAM device 402 of FIG. 4, the example IAM device 502 of FIG. 5 generates both the server tokens 508 and the user token 106 based on instructions from the server devices 504 and the tenant device 102, respectively. In other examples, the user token 106 is generated by a different IAM device that is external from, but still trusted by, the private network 108. The IAM device 502 also provides instructions that describe how a device that receives a token is to perform operations to authenticate the token. The IAM device 502 may be implemented using any type of programmable circuitry. In some examples, the IAM device 502 is instantiated by programmable circuitry executing IAM instructions and/or configured to perform operations such as those represented by the flowchart(s) of FIGS. 6-8 .

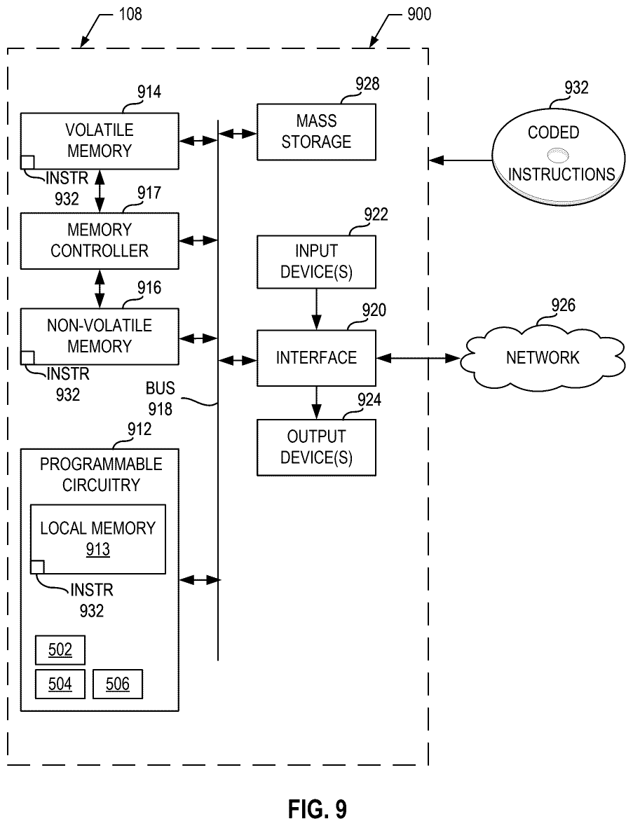

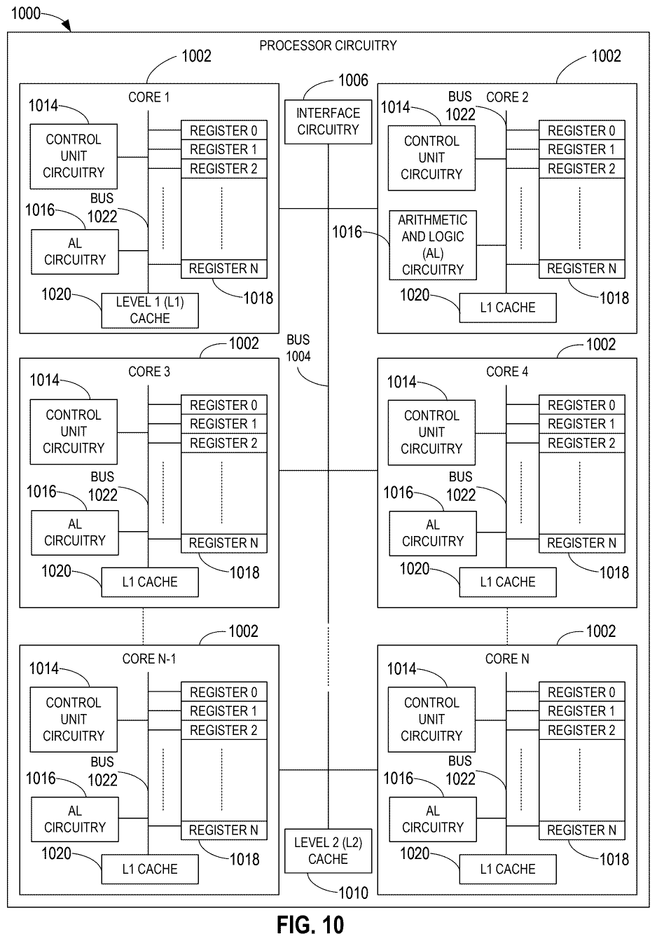

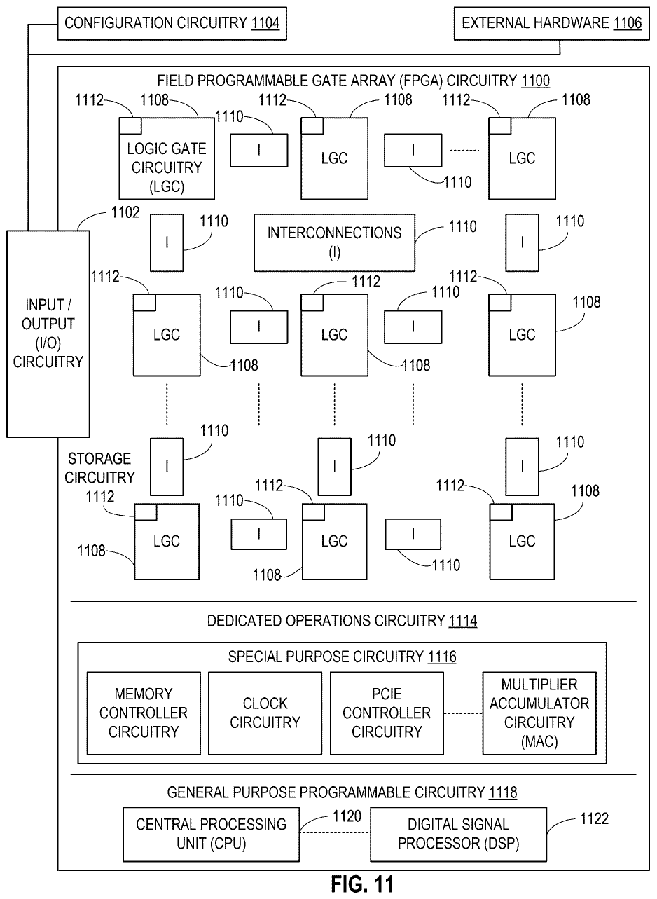

In some examples, the private network 108 includes means for minting a token and means for providing authentication instructions. For example, the means for determining and means for providing authentication instructions may be implemented by IAM device 502. In some examples, the IAM device 502 may be instantiated by programmable circuitry such as the example programmable circuitry 912 of FIG. 9. For instance, the IAM device 502 may be instantiated by the example microprocessor 1000 of FIG. 10 executing machine executable instructions such as those implemented by at least blocks 602-606 of FIG. 6. In some examples, the IAM device 502 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the IAM device 502 may be instantiated by any other combination of hardware, software, and/or firmware. For example, the IAM device 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The server devices 504 are devices that work together to respond to requests. In the example of FIG. 5, each of the server devices 504A, 504B, . . . , 504-n are part of a service chain that collectively work together to form the response 110 based on the request 104. In other examples, a different subset of the server devices 504 work in a different order to form a different response to a different request. The private network 108 may include any number of server devices 504.

As used above and herein, a service chain refers to an ordered list of the server devices that responds to a request, where the first server device in the chain receives the request directly from the tenant and the last server device in the chain generates the response to the request. In the example of FIG. 5, the response 110 to the request 104 is formed by a service chain where the first device in the chain is server device 504A and the last device in the chain is server device 504-n. More generally, the private network 108 may form a different service chain to respond to a different request.

As used above and herein, a first server device is “upstream” of a second server device if a) both the first server device and the second server device are part of the same service chain and b) the first server device performs operations in the service chain before the second server device. Thus, in the example of FIG. 5, the server device 504A is upstream of server devices 504B, . . . , 504-n. Similarly, a second server device is “downstream” of a first server device if a) both the first server device and the second server device are part of the same service chain and b) the second server device performs operations in the service chain after the first server device. Thus, in the example of FIG. 5, the server device 504-n is downstream of server devices 504A, 504B, . . . , 504-(n−1).

In general, a service chain may include any number of server devices 504 in any order. A service chain may also include a device more than once. For example, the user token may flow from server device 504A to the server device 504B, then back to server device 504A, then may continue to a next device in the service chain, etc. In such examples, the server device that receives the user token more than once may use different inputs and/or perform different operations each time it receives the user token.

Like the server device 404A of FIG. 4, the example server device 504A is implemented at the edge of the private network 108 and thus receives both the request 104 and the user token 106 from the tenant device 102. The server device 504A also uses the user token 106 to verify the identity of the tenant device 102 and confirm the tenant device 102 is authorized to submit the request 104. However, while the server device 404A in the previous approach forwards only the tenant ID 202 to the server device 404B, the server device 504A in examples described herein forwards the entire user token 106 to the server device 504. Forwarding the entire user token 106 allows any of the server devices 504B, . . . , 504-n downstream in the service chain to use the authentication data 214 to verify contents of the user token 106 (e.g., the tenant ID 202) have not changed. Thus, even if the private network 108 is compromised by a malicious device 506 that can obtain the original user token 106, the malicious device 506 has no reason to spoof the tenant ID 202 because any server device that receives such an edited user token can use the authentication data 214 to determine the data structure is invalid/not original. In some examples, a subsequent authentication of a user token that a server device performs downstream may be referred to as reauthentication.

In the example of FIG. 5, intermediate server devices 504 continue to forward the user token 106 across the length of a service chain. Accordingly, the server device 504-n receives the full user token 106, uses the authentication data 214 to verify the tenant ID 202 is unedited, obtains data from the network database 300 using the tenant ID 202, and transmits a correct response 110 back to the tenant device 102.

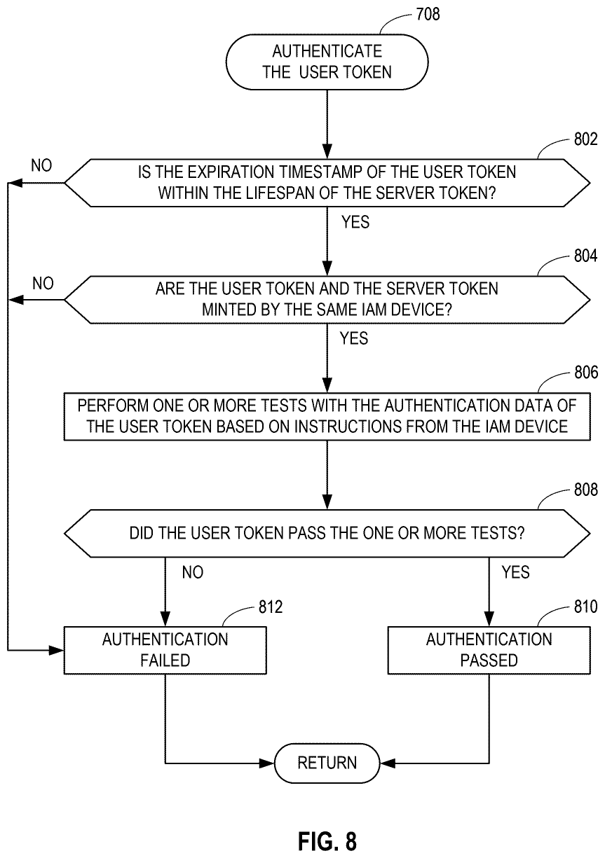

A given server device (e.g., 504A) in the private network 108 can authenticate the user token 106 and/or forward the user token 106 to another server device (e.g., 504B). The operations performed by a server device to authenticate a user token 106 are described further in connection with FIG. 8.

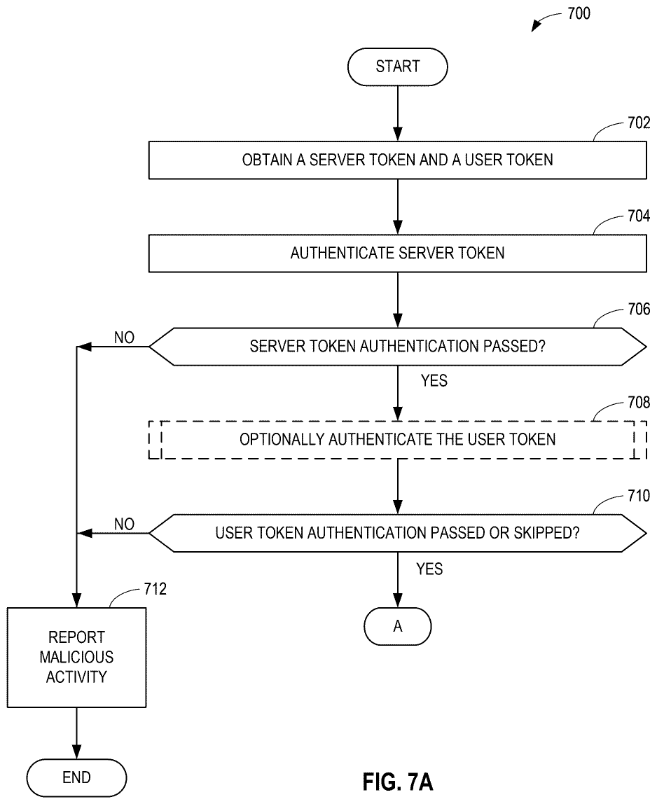

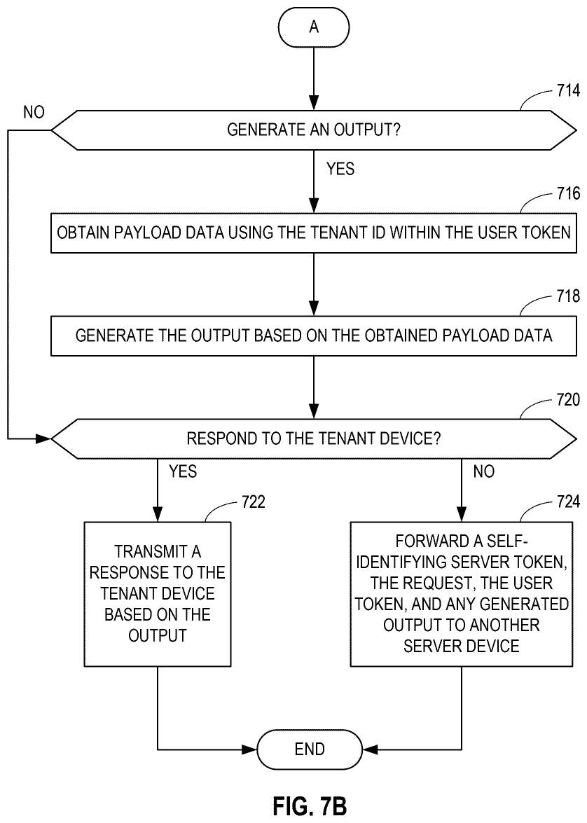

Notably, verification of the user token 106 is optional on a per-server basis. Thus, for a given user token provided to the private network 108, a first subset of the server devices 504 in the service chain may verify the user token before forwarding the token downstream while a second, mutually exclusive subset of the server devices 504 does skip verification of the user token. In some examples, a given server device determines whether to verify the user token independently of the other server devices 504. In other examples, an organization that manages the private network 108 instructs one or more of the server devices 504 to verify or not verify a user token. The decision of whether to reauthenticate the user token 106 is described further in connection to FIG. 7A.

A given server device (e.g., 504A) in the private network 108 can also generate an output. The output generated by the server device may be the result of any type of operations on any number of inputs. Such inputs include but are not limited to the request 104, the user token 106, the server token of the preceding server device that is upstream in the service chain, one or more outputs provided by server devices upstream in the service chain, the network database 300, etc. While only the server device 504-n accesses the network database 300 in the example of FIG. 5, more generally, any number of server devices 504 in the service chain may access the network database 300 based on the type of request 104 and the role of said device within the corresponding service chain.

The network database 300 is implemented by any memory, storage device and/or storage disc for storing data such as, for example, flash memory, magnetic media, optical media, solid state memory, hard drive(s), thumb drive(s), etc. Furthermore, the data stored in the network database 300 may be in any data format such as, for example, binary data, comma delimited data, tab delimited data, structured query language (SQL) structures, etc. While, in the illustrated example, the network database 300 is illustrated as a single device, the network database 300 and/or any other data storage devices described herein may be implemented by any number and/or type(s) of memories.

A given server device (e.g., 504C) may forward its generated output to the next server device in the service chain, or, if the server device is at the end of the service chain (e.g., 504-n), transmit its generated output to the tenant device 102 as the response 110. In some examples, the server device is instantiated by programmable circuitry executing server instructions and/or configured to perform operations such as those represented by the flowchart(s) of FIGS. 6-8.

In some examples, the private network 108 includes means for authenticating a user token, means for forwarding a user token, means for generating an output, and means for forwarding an output. For example, the means for authenticating a user token, means for forwarding a user token, means for generating an output, and means for forwarding an output may be implemented by server devices 504. In some examples, the server devices 504 may be instantiated by programmable circuitry such as the example programmable circuitry 912 of FIG. 9. For instance, the server devices 504 may be instantiated by the example microprocessor 1000 of FIG. 10 executing machine executable instructions such as those implemented by at least blocks 702-724, 802-810 of FIGS. 7A-8. In some examples, the server devices 504 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the server devices 504 may be instantiated by any other combination of hardware, software, and/or firmware. For example, the server devices 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Like the malicious device 406 of FIG. 4, the malicious device 506 in FIG. 5 refers to a device within the private network 108 that has been compromised and can obtain one of the server tokens 508. However, while the server devices 404 implicitly trust any device that can identify itself with a server token, the server devices 504 in the example of FIG. 5 operate with the knowledge that even a device with one of the server tokens 508 can become compromised. In some examples, the malicious device 506 is instantiated by programmable circuitry executing malicious instructions and/or configured to perform operations such as those represented by the flowchart(s) of FIG. 6-8.

In the example of FIG. 5, the malicious device 506 obtains a copy of the user token 106 but does not transmit data to the server device 504-n. However, even if the malicious device 506 did attempt to trigger an improper request 110 by sending an alternate user token or an edited version of the user token 106, the server device 504-n can identify the malicious behavior by performing authentication operations on said invalid token. In such an example, the server device 504-n does not use the invalid token to generate an output and may additionally report the sender of the token (e.g., the malicious device 506) of malicious activity. Thus, while individual devices within the private network 108 may become compromised, forwarding the user token 106 throughout the service chain prevents the compromise from affecting the response 110 and, more generally, limits the security vulnerabilities of the private network 108. As used above and herein, an invalid token refers to any token (e.g., a user token or a server token) that is sent by a malicious device with an intent to deceive a target device downstream in a service chain. An invalid token may be an edited version of a valid token, an unedited copy of an old token, etc.

While an example manner of implementing the private network 108 of FIG. 1 is illustrated in FIG. 5, one or more of the elements, processes, and/or devices illustrated in FIGS. 1 and 5 may be combined, divided, re-arranged, omitted, eliminated, and/or implemented in any other way. Further, the IAM device 502, the server devices 504, the malicious device 506, the network database 300, and/or, more generally, the example private network 108 of FIGS. 1 and 5, may be implemented by hardware alone or by hardware in combination with software and/or firmware. Thus, for example, any of the IAM device 502, the server devices 504, the malicious device 506, the network database 300, and/or, more generally, the example private network 108, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example private network 108 of FIGS. 1 and 5 may include one or more elements, processes, and/or devices in addition to, or instead of, those illustrated in FIGS. 1 and 5, and/or may include more than one of any or all of the illustrated elements, processes and devices.

Flowcharts representative of example machine readable instructions, which may be executed by programmable circuitry to implement and/or instantiate the private network 108 of FIGS. 1 and 5 and/or representative of example operations which may be performed by programmable circuitry to implement and/or instantiate the private network 108 of FIGS. 1 and 5, are shown in FIGS. 6-8. The machine readable instructions may be one or more executable programs or portion(s) of one or more executable programs for execution by programmable circuitry such as the programmable circuitry 912 shown in the example programmable circuitry platform 900 described below in connection with FIG. 9 and/or may be one or more function(s) or portion(s) of functions to be performed by the example programmable circuitry (e.g., an FPGA) described below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-8 , many other methods of implementing the example private network 108 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by example programmable circuitry to implement the IAM device 502 as described in FIG. 5. The machine readable instructions and/or operations 600 begin when the IAM device 502 mints a user token 106. (Block 602). The IAM device 502 mints the user token 106 based on a request from a tenant device 102. The user token 106 identifies the IAM device 502, identifies the tenant device 102, has a lifespan, includes authorization data, and may additionally include other information as described above in connection with FIG. 2. More generally, the IAM device 502 may mint any number of user tokens based on any number of requests from one or more tenant devices at block 602.

The IAM device 502 mints a server token 508B. (Block 604). Like user tokens, the IAM device 502 mints the server token 508B in response to a request from a server device 504B. In general, the server devices 504 do not request server tokens on an ad hoc or per-request basis. Rather, a given server device 504B requests a new server token from the IAM device 502 on a periodic basis once its previous server token expires. Generally, the server device 504B only stops requesting new server tokens if it also stops contributing to service chains. A server device may stop contributing to service chains on either a temporary or permanent basis for any reason, including but not limited to the device powering off, the device choosing to or being forced to leave the private network 108, etc. The server token 508B identifies the IAM device 502, identifies the server device 504B, has a lifespan, includes authorization data, and may additionally include other information as described above in connection with FIG. 2. More generally, the IAM device 502 may mint any number of server tokens 508 based on any number of requests from the server devices 504 at block 604.

In general, a token represents a temporary authorization from the IAM device 502 for a particular device to perform certain operations. This authorization can only be meaningful if a server device 504B that receives a user token or server token is able to confirm the token is valid. Thus, the IAM device 502 provides instructions to perform one or more tests using authentication data within a minted token. (Block 606). The IAM device 502 provides the instructions based on a request from a server device 504B that is attempting to authenticate a token. The tests of block 606 are described further in connection with FIG. 8.

The machine-readable instructions and/or operations 600 end after block 606. In some examples, the IAM device 502 implements the machine-readable instructions and/or operations 600 by performing one or more of block 602, 604, and/or 606 in parallel with one another.

FIGS. 7A and 7B are flowcharts representative of example machine readable instructions and/or example operations 700 that may be executed, instantiated, and/or performed by programmable circuitry to implement one of the server devices 504. While the examples described below refer to server device 504B unless otherwise indicated, the machine readable instructions and/or operations 700 may be implemented by any of the server devices 504A, 504B, . . . , 504-n. Similarly, while the examples described below refer to the service chain shown in FIG. 5, the machine-readable instructions and/or the example operations 700 may be implemented by any service chain (e.g., any subset of the server devices 504 that communicate with one another in any order).

The example machine-readable instructions and/or the example operations 700 begin on FIG. 7A when the server device 504B obtains both a server token 508A and the user token 106. (Block 702). In most examples, the obtained server token 508A represents the identity of the server device 504A that is one device upstream in the service chain. In such examples, the server device 504B receives both tokens of block 702 from the server device 504A that is one device upstream in the service chain. In examples where the machine-readable instructions and/or the example operations 700 are implemented by a server device (e.g. 504A) at the start of a service chain, the server device 504A receives the user token 106 directly from the tenant device 102 as opposed to receiving the user token 106 from a different service device upstream. Accordingly, the server device 504A does not receive a server token at block 702 in such examples.

The server device 504B authenticates the server token 508A of block 702. (Block 704). To perform server token authentication, the server device 504B first identifies the IAM device (e.g., 502) that minted the server token 508A and confirms the IAM device is a trusted source. As described above at block 606 of FIG. 6, the server device 504B then performs one or more authentication operations that use the server token 508A as an input based on instructions from the IAM device 502.

In examples disclosed herein, a token may either pass or fail authentication. Accordingly, the server device 504B determines whether the server token 508A has passed the authentication operations of block 704. (Block 706). If the server token fails authentication (Block 706: No), control proceeds to block 712.

If the server token passes authentication (Block 706: Yes), the server device 504 optionally authenticates the user token 106. (Block 708). The decision for a server device to authenticate a user token, whether it is made by a managing organization or the server device itself, may be made for any reason. For example, in FIG. 5, the server device 504A authenticates the user token 106 because the server device 504A sits at the edge of the private network 108 and is the first device within the private network 108 to receive the user token 106. As another example, server devices that rely on the tenant ID to generate an output (e.g., the server device 504-n) may authenticate the user token because using an incorrect/altered token can expose the network to security vulnerabilities. But server devices that merely forward the user token without using it to generate an output (e.g., 504B) may decide not to authenticate the user token because the authentication can happen downstream at more security critical operations.

A server device 504B may authenticate or not authenticate the user token 106 for different reasons. For example, the server devices 504 may perform authentication operations more frequently when the user token is forwarded from a device that is suspected of being compromised by a man-in-the-middle attack.

In another example, a managing organization instructs a specific subset of the server devices 504 to skip authentication of the user token 106 based at least in part on where computational resources are available throughout the private network 108. Thus, while authenticating the user token does add computational burden compared to merely forwarding the user token, the examples disclosed herein can increase security throughout the private network 108 without proportionally increasing the computational burden. Block 708 is described further in connection with FIG. 8.

The server device 504B determines whether authentication of the user token 106 has been passed or skipped. (Block 710). If the server authentication operations of block 704 failed (Block 706: No), or if the user authentication operations of block 708 failed (Block 710: No), the server device 504B reports malicious activity. (Block 712). Reporting malicious activity may include but is not limited to informing the tenant device 102, a managing organization of the private network 108, and/or the other server devices 504 which token authentication failed, instructing the rest of the server devices 504 to stop performing operations that correspond to the invalid token, etc. The machine-readable instructions and/or operations 700 end after block 712.

Alternatively, if the user token authentication operations of block 708 were either passed or skipped (Block 710: Yes), control flows to FIG. 7B where the server device 504B determines whether to generate an output. (Block 714). In general, the server device 504B generate an output if doing so will help generate the response 110 that is ultimately transmitted back to the tenant device 102 at the end of the service chain. Accordingly, the determination of block 714 may be based on factors including but not limited to the contents of the user token 106, the contents of the request 104, and the computational capabilities of the server device 504B.

If the server device 504B determines not to generate an output (Block 714: No), control proceeds to block 720. Alternatively, if the server device 504B does determine to generate an output (Block 714: Yes), the server device 504B obtains one or more portions of the response data 304 using the tenant ID 202 within the user token 106. (Block 716). The values of the response data at block 716 is dependent on the tenant ID 202 as described above in connection with FIG. 3. In the example of FIG. 5, the response data 304 is stored in the network database 300 and accessed only by the server device 504-n. In other examples, the response data 304 may be stored in any number of memory devices throughout the private network and accessed by any number of server devices.

The server device 504B generates an output based on the obtained response data. (Block 718). The server device 504B may perform any number and any type of operations using the response data of block 716 to generate the output.

The server device 504B determines whether to respond to the tenant device 102. (Block 720). In general, a server device responds to a tenant device when it is at the end of the service chain. Thus, because the number and order of server devices 504 in a service chain is dependent on the contents of the request 104, the server device 504B evaluates block 720 based on the contents of the request 104.

If the server device 504B decides to respond to the tenant device 102 (Block 720: Yes), the server device 504B transmits the response 110 to the tenant device 102 based on the output. (Block 722). In some examples, the server device 504B forms the response 110 by reformatting, packaging, and/or, more generally, editing, the output of block 718 to comply with one or more communication protocols. The machine-readable instructions and/or operations 700 end after block 722.

Alternatively, if the server device 504B does not respond to the tenant device 102 (Block 720: No), the server device 504B forwards a self-identifying server token, the request 104, the user token 106, and any output generated at block 718, to another server device. (Block 724). The data forwarded at block 724 allows the next server device in the service chain to: a) reverify the user token 106 if necessary, and b) perform operations that assist in generating the request 110. The machine-readable instructions and/or operations 700 end after block 724.

In the example of FIGS. 7A-7B, the machine-readable instructions and/or operations 700 are implemented by each of the server devices 504 in parallel with one another. Thus, even if a server device 504B receives an invalid user token at block 702 and does not authenticate the token at block 708, a different server device 504C that is downstream in a service chain can authenticate the token at block 708 and report malicious activity at block 712 instead of generating an output. More generally, by implementing the machine-readable instructions and/or operations 700, the server devices 504 authenticate one or more operations of a service chain to ensure the response 110 is accurate and not effected by the malicious device 506.

FIG. 8 is a flowchart representative of example machine readable instructions and/or example operations that may be executed, instantiated, and/or performed by example programmable circuitry to authenticate a user token as described in FIG. 7. In particular, the flowchart of FIG. 8 is an example implementation of block 708 of FIG. 7.

In previous approach of FIG. 4, authentication of a user token involves determining whether the server device 404A received the user token within the lifespan of the user token (e.g., after the minting timestamp 204 but before the expiration timestamp 206). Such a check allows the server device 404A to confirm it did not receive an old token that is being retransmitted for malicious purposes.

Generally, user tokens are designed with relatively short lifespans (e.g., ten minutes) that reflect a presumption that only the first server device in a private network will authenticate the user token. Thus, while the server device 504A may receive the user token 106 within the lifespan of the user token 106, it is possible that one or more server devices 504 downstream in the service chain (e.g., 504B, . . . , 504-n) will receive the user token 106 after it has expired. Accordingly, execution of block 708 begins when the server device 504B determines whether the expiration timestamp of the user token 106 is within the lifespan of the server token 508A. (Block 802).

Server tokens have comparatively long lifespans (e.g., twenty four hours) and are therefore likely to remain active throughout the duration of operations performed by a service chain. Thus, checking whether the user token of block 702 expires within the lifespan of the server token of block 702 acknowledges that a server device 504B may a) receive a valid-but-expired user token and b) limits the capability for the malicious device 506 to disguise an old user token as valid. The server device 504B performs the check using data within the user token and the server token of block 702. In the example of FIG. 8, both tokens include minting timestamps and expiration timestamps as described above in connection with FIG. 2. In some examples, the server device 504B implements block 802 by checking whether the minting timestamp of the user token is within the lifespan of the server token.

If the expiration timestamp of the user token is outside the lifespan of the server token (Block 802: No), control proceeds to block 812. Alternatively, if the expiration timestamp of the user token is within the lifespan of the server token (Block 802: Yes), the server device 504B then determines whether the user token and the server token of block 702 are minted by the same IAM device. (Block 804). The server device 504B executes block 804 because, in the example of FIG. 5, the server tokens 508 and the user token 106 are both minted by the same IAM device 502. Thus, the check of block 804 prevents the malicious device 506 from disguising an invalid user token from a different IAM device as the valid token, even if the invalid token has not yet expired.

In other examples besides FIG. 5, the server tokens 508 and the user token 106 are minted by different IAM devices. In such examples, the server device 504B implements block 804 by determining whether the user token and server token are both minted by one of a group of trusted IAM devices. The server device 504B implements block 804 by reading the source parameters 208 that are present in both the user token and server token.

If the source(s) of the user token and server token fail the foregoing examination (Block 804: No), control proceeds to block 812. Alternatively, if the source(s) of the user token and server token pass the foregoing examination (Block 804: Yes), the server device 504B then performs one or more tests with the authentication data 214 of the user token 106 based on instructions from IAM device 502. (Block 806). The tests performed at block 806 are dependent on the type of authentication data 214 stored in the user token (which may include but is not limited to a hash value, a check sum, a public or private key, etc.). In general, the IAM device 502 may instruct the server device 504B at block 606 of FIG. 6 to use any type of cryptographic, encryption, or other operations to perform the one or more tests.

The server device 504B determines whether the user token 106 passed the one or more tests. (Block 808). If the server device 504B passes the one or more tests (Block 808: Yes), the user token 106 as a whole passes authentication. (Block 810). In such examples, control returns to block 710 of FIG. 7A and then block 714 of FIG. 7B as described above. Alternatively, if the server device 504B fails one or more of the tests (Block 808: No), or if the source(s) of the user token and server token fail the authentication described above (Block 804: No), or if the expiration of the timestamp of the user token falls outside the lifespan of the server token (Block 802: No), the user token has failed authentication and is invalid (Block 812). In such examples, control returns to block 710 and then block 712 of FIG. 7A as described above.

FIG. 9 is a block diagram of an example programmable circuitry platform 900 structured to execute and/or instantiate the example machine-readable instructions and/or the example operations of FIGS. 6-8 to implement the private network 108 of FIGS. 1 and 5. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements one or more portions of the IAM device 502, the server devices 504, and the malicious device 506.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 6-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 6-8 to effectively instantiate the circuitry of FIGS. 1 and 5 as logic circuits to perform operations corresponding to those machine readable instructions. In some such examples, the circuitry of FIGS. 1 and 5 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 6-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-8. As such, the FPGA circuitry 1100 may be configured and/or structured to effectively instantiate some or all of the operations/functions corresponding to the machine readable instructions of the flowchart(s) of FIGS. 6-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 6-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 6-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIG. 6-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 6-8 , and/or an ASIC may be configured and/or structured to perform third operation(s)/function(s) corresponding to a third portion of the machine readable instructions represented by the flowcharts of FIGS. 6-8.

Some or all of the circuitry of FIGS. 1 and 5 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIGS. 1 and 5 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIGS. 1 and 5 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

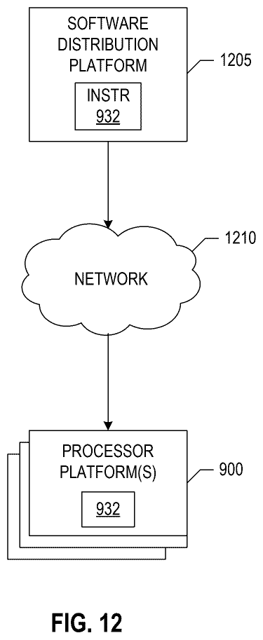

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 6-8 , as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 6-8 , may be downloaded to the example programmable circuitry platform 900, which is to execute the machine readable instructions 932 to implement the private network 108. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” “fourth,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/ −11% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement a service chain with secure intra-network communications. Thus, even if a malicious actor does gain access to an example network, a server device in the example service chain is able to identify if it has received an edited tenant ID because the edited user token will fail authentication. Disclosed systems, apparatus, articles of manufacture, and methods improve the efficiency of using a computing device by optionally verifying the user token and forwarding the user token so that other devices in the service chain can do the same. Verifying the user token includes checking if a timestamp of the user token is within the lifespan of the server token, checking the source of the user token and the source of the server token, and performing one or more tests with the authentication data of the user token. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to authenticate service chains are disclosed herein. Further examples and combinations thereof include the following.

Example 1 includes a system to authenticate a service chain, the system comprising a first server device in a network, the first server device to receive a user token from a tenant device that is outside the network, authenticate the user token, and after the authentication, forward the user token and a server token, and a second server device in the network, the second server device to receive the user token and the server token from the first server device, authenticate the server token, reauthenticate the user token, and in response to determinations that the server token passes authentication and the user token passes reauthentication, generate an output based on a value within the user token that identifies the tenant device.

Example 2 includes the system of example 1, wherein the second server device is to transmit a response to the tenant device based on the output.

Example 3 includes the system of example 2, wherein to reauthenticate the user token, the second server device is to check whether an expiration timestamp of the user token is within a lifespan of the server token.

Example 4 includes the system of example 2, wherein to reauthenticate the user token, the second server device is to check whether the user token was generated within a lifespan of the server token.

Example 5 includes the system of example 1, wherein the network further includes an Identity Access Manager (IAM) device to generate tokens, and to reauthenticate the user token, the second server device is to check whether the user token and the server token are generated by the same IAM device.

Example 6 includes the system of example 1, wherein to reauthenticate the user token, the second server device is to perform one or more tests with authentication data from the user token as an input.

Example 7 includes the system of example 6, wherein the second server device is to obtain instructions corresponding to the one or more tests from an Identity Access Manager (IAM) device that generated the user token.

Example 8 includes the system of example 7, wherein the IAM device is implemented within the network.

Example 9 includes the system of example 7, wherein the IAM device is implemented external to the network.

Example 10 includes the system of example 1, wherein the network further includes a third server device between the first server device and the second server device, and the third server device forwards the user token to the second server device without reauthenticating the user token.

Example 11 includes a non-transitory machine readable storage medium comprising instructions to cause programmable circuitry to at least authenticate a server token that is provided by a first external device, reauthenticate a user token that was previously authenticated by the first external device, and in response to determinations that a) the server token passes authentication and b) the user token pass reauthentication, generate an output based on a value within the user token that identifies a second external device.

Example 12 includes the non-transitory machine readable storage medium of example 11, wherein the instructions cause the programmable circuitry to transmit a response to the second external device based on the output.

Example 13 includes the non-transitory machine readable storage medium of example 12, wherein to reauthenticate the user token, the instructions cause the programmable circuitry to check whether an expiration timestamp of the user token is within a lifespan of the server token.

Example 14 includes the non-transitory machine readable storage medium of example 12, wherein to reauthenticate the user token, the instructions cause the programmable to check whether the user token was generated within a lifespan of the server token.

Example 15 includes the non-transitory machine readable storage medium of example 11, wherein to reauthenticate the user token, the instructions cause the programmable to check whether the instructions cause the programmable circuitry to reauthenticate the user token by checking whether the user token and the server token are generated by the same Identity Access Manager (IAM) device.

Example 16 includes the non-transitory machine readable storage medium of example 11, wherein the instructions cause the programmable circuitry to reauthenticate the user token by performing one or more tests with authentication data from the user token as an input.

Example 17 includes the non-transitory machine readable storage medium of example 16, wherein the instructions cause the programmable circuitry to perform the one or more tests based on instructions from an Identity Access Manager (IAM) device that generated the user token.

Example 18 includes an apparatus to authenticate a service chain, the apparatus comprising interface circuitry, machine readable instructions, and programmable circuitry to at least one of instantiate or execute the machine readable instructions to authenticate a server token that is provided by a first external device, reauthenticate a user token that was previously authenticated by the first external device, and in response to determinations that a) the server token passes authentication and b) the user token pass reauthentication, generate an output based on a value within the user token that identifies a second external device.

Example 19 includes the apparatus of example 18, wherein the instructions cause the programmable circuitry to transmit a response to the second external device based on the output.

Example 20 includes the apparatus of example 19, wherein to reauthenticate the user token, the instructions cause the programmable circuitry to check whether an expiration timestamp of the user token is within a lifespan of the server token.

Example 21 includes the apparatus of example 19, wherein to reauthenticate the user token, the instructions cause the programmable to check whether the user token was generated within a lifespan of the server token.

Example 22 includes the apparatus of example 18, wherein to reauthenticate the user token, the instructions cause the programmable to check whether the instructions cause the programmable circuitry to reauthenticate the user token by checking whether the user token and the server token are generated by the same Identity Access Manager (IAM) device.

Example 23 includes the apparatus of example 18, wherein the instructions cause the programmable circuitry to reauthenticate the user token by performing one or more tests with authentication data from the user token as an input.

Example 24 includes the apparatus of example 23, wherein the instructions cause the programmable circuitry to perform the one or more tests based on instructions from an Identity Access Manager (IAM) device that generated the user token.

Example 25 includes a method to authenticate service chains, the method comprising authenticating a server token that is provided by a first external device, reauthenticating a user token that was previously authenticated by the first external device, and in response to determinations that a) the server token passes authentication and b) the user token pass reauthentication, generating an output based on a value within the user token that identifies a second external device.

Example 26 includes the method of example 25, further including transmitting a response to the second external device based on the output.

Example 27 includes the method of example 26, wherein reauthenticating the user token further includes checking whether an expiration timestamp of the user token is within a lifespan of the server token.

Example 28 includes the method of example 26, wherein reauthenticating the user token further includes checking whether the user token was generated within a lifespan of the server token.

Example 29 includes the method of example 25, further including reauthenticating the user token by checking whether the user token and the server token are generated by the same Identity Access Manager (IAM) device.

Example 30 includes the method of example 25, wherein reauthenticating the user token further includes performing one or more tests with authentication data from the user token as an input.

Example 31 includes the method of example 30, further including performing the one or more tests based on instructions from an Identity Access Manager (IAM) device that generated the user token.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A system to authenticate a service chain, the system comprising:
a first server device in a network, the first server device to:
receive a user token from a tenant device that is outside the network;
authenticate the user token; and
after the authentication, forward the user token and a server token; and
a second server device in the network, the second server device to:
receive the user token and the server token from the first server device;
authenticate the server token;
reauthenticate the user token; and
in response to determinations that the server token passes authentication and the user token passes reauthentication, generate an output based on a value within the user token that identifies the tenant device.

2. The system of claim 1, wherein the second server device is to transmit a response to the tenant device based on the output.

3. The system of claim 1, wherein to reauthenticate the user token, the second server device is to check whether an expiration timestamp of the user token is within a lifespan of the server token.

4. The system of claim 1, wherein to reauthenticate the user token, the second server device is to check whether the user token was generated within a lifespan of the server token.

5. The system of claim 1, wherein:
the network further includes an Identity Access Manager (IAM) device to generate tokens; and
to reauthenticate the user token, the second server device is to check whether the user token and the server token are generated by the same IAM device.

6. The system of claim 1, wherein to reauthenticate the user token, the second server device is to perform one or more tests with authentication data from the user token as an input.

7. The system of claim 6, wherein the second server device is to obtain instructions corresponding to the one or more tests from an Identity Access Manager (IAM) device that generated the user token.

8. The system of claim 7, wherein the IAM device is implemented within the network.

9. The system of claim 7, wherein the IAM device is implemented external to the network.

10. The system of claim 1, wherein:
the network further includes a third server device between the first server device and the second server device; and
the third server device forwards the user token to the second server device without reauthenticating the user token.

11. A non-transitory machine readable storage medium comprising instructions to cause programmable circuitry to at least:
authenticate a server token that is provided by a first external device;
reauthenticate a user token that was previously authenticated by the first external device; and
in response to determinations that a) the server token passes authentication and b) the user token pass reauthentication, generate an output based on a value within the user token that identifies a second external device.

12. The non-transitory machine readable storage medium of claim 11, wherein the instructions cause the programmable circuitry to transmit a response to the second external device based on the output.

13. The non-transitory machine readable storage medium of claim 11, wherein to reauthenticate the user token, the instructions cause the programmable circuitry to check whether an expiration timestamp of the user token is within a lifespan of the server token.

14. The non-transitory machine readable storage medium of claim 11, wherein to reauthenticate the user token, the instructions cause the programmable circuitry to check whether the user token was generated within a lifespan of the server token.

15. The non-transitory machine readable storage medium of claim 11, wherein to reauthenticate the user token, the instructions cause the programmable circuitry to check whether the instructions cause the programmable circuitry to reauthenticate the user token by checking whether the user token and the server token are generated by the same Identity Access Manager (IAM) device.

16. The non-transitory machine readable storage medium of claim 11, wherein the instructions cause the programmable circuitry to reauthenticate the user token by performing one or more tests with authentication data from the user token as an input.

17. The non-transitory machine readable storage medium of claim 16, wherein the instructions cause the programmable circuitry to perform the one or more tests based on instructions from an Identity Access Manager (IAM) device that generated the user token.

18. An apparatus to authenticate a service chain, the apparatus comprising:
interface circuitry;
machine readable instructions; and
programmable circuitry to at least one of instantiate or execute the machine readable instructions to:
authenticate a server token that is provided by a first external device;
reauthenticate a user token that was previously authenticated by the first external device; and
in response to determinations that a) the server token passes authentication and b) the user token pass reauthentication, generate an output based on a value within the user token that identifies a second external device.

19. The apparatus of claim 18, wherein the instructions cause the programmable circuitry to transmit a response to the second external device based on the output.

20. The apparatus of claim 18, wherein to reauthenticate the user token, the instructions cause the programmable circuitry to check whether an expiration timestamp of the user token is within a lifespan of the server token.
